(19) United States
(12) Patent Application Publication
(10) Pub. No.: US 2025/0298137 A1
(43) Pub. Date: Sep. 25, 2025

(54) Ultra-Wideband Sensing Systems, Methods, and Devices for Multiple-Target Detection

(71) Applicant: Qorvo US, Inc., Greensboro, NC (US)

(72) Inventors: Lisa Meilhac, Valbonne (FR); Saad Mdaa, Toulouse (FR)

(21) Appl. No.: 19/073,832

(22) Filed: Mar. 7, 2025

Related U.S. Application Data
(60) Provisional application No. 63/567,638, filed on Mar. 20, 2024.

(51) Int. Cl. G01S 13/42; G01S 13/02; G01S 13/72

(52) U.S. Cl. CPC G01S 13/42; G01S 13/0209; G01S 13/726

(57) ABSTRACT

Ultra-wideband sensing systems, methods, and devices for multiple-target detection are disclosed. In an exemplary aspect, a method of sensing operation performed by an UWB device is disclosed. The method of sensing operation includes determining a first matrix based on one or more estimated channel impulse responses. The method may also include determining a first set of eigenvectors and a first set of eigenvalues based on the first matrix. The method may also include determining a second set of eigenvectors by identifying which of the first set of eigenvectors corresponds to a number of the largest of the first set of eigenvalues, where the number is equal to an estimated number of targets; and determining a propagation delay value for each of the estimated number of targets based on the second set of eigenvectors.

### CROSS-REFERENCE TO RELATED APPLICATIONS

The present application claims the benefit of U.S. Provisional Application No. 63/567,638, entitled “Ultra-Wideband Sensing Systems, Methods, and Devices for Multiple-Target Detection” and filed on Mar. 20, 2024, which is incorporated herein by reference in its entirety.

### TECHNICAL FIELD

The present disclosure relates generally to ultra-wideband wireless sensing technology, and, more specifically to systems, methods, and devices for detection of multiple targets in ultra-wideband sensing scenarios.

### BACKGROUND

Ultra-wideband (UWB) sensing systems, including UWB-based radar systems, typically sense the environment by obtaining propagation channel measures. In UWB systems, the channel measures may take the form of a set of periodic channel impulse response estimations (CIRE). A channel impulse response (CIR) generally represents the convolution of the propagation channel due to the reflections of the transmitted signal on the environment with a band limited low pass filter generally including the effect of the transmit and receive filter impulse responses. A CIRE's complex components, commonly referred to as “taps,” generally correspond to a propagation delay of a reflected signal and thus to a reflecting target's distance. However, because of the time spreading introduced by filtering, one given target's movement may impact several taps of a CIRE and the reflections of the different targets may overlap. Algorithms the consider only the evolution of the variance of the taps may not be able to identify the presence of multiple targets. Thus, there remains a need for effective techniques to accurately detect and locate multiple moving targets using an UWB sensing system.

### SUMMARY

Embodiments of the present disclosure include systems, devices, and methods for detection of multiple targets in UWB sensing.

In an exemplary aspect, a method of sensing operation performed by an UWB device is disclosed. The method of sensing operation includes determining a first matrix based on one or more estimated channel impulse responses. The method may also include determining a first set of eigenvectors and a first set of eigenvalues based on the first matrix. The method may also include determining a second set of eigenvectors by identifying which of the first set of eigenvectors corresponds to a number of the largest of the first set of eigenvalues, where the number is equal to an estimated number of targets; and determining a propagation delay value for each of the estimated number of targets based on the second set of eigenvectors.

In another exemplary aspect, an UWB device is disclosed, wherein the UWB device includes a processor. In some embodiments, the processor is configured to determine a first matrix based on or more estimated channel impulse responses; and determine a first set of eigenvectors and a first set of eigenvalues based on the first matrix. The processor may further be configured to determine a second set of eigenvectors by identifying which of the first set of eigenvectors corresponds a number of the largest of the first set of eigenvalues, wherein the number is equal to an estimated number of targets; and determine a propagation delay value for each of the estimated number of targets based on the second set of eigenvectors.

In another exemplary aspect, non-transitory computer-readable medium (CRM) having program code recorded thereon is disclosed. In some embodiments, the program code includes code for causing an ultra-wideband (UWB) device to determine a first matrix based on one or more estimated channel impulse responses; and code for causing the UWB device to determine a first set of eigenvectors and a first set of eigenvalues based on the first matrix. The program code may further include code for causing the UWB device to determine a second set of eigenvectors by identifying which of the first set of eigenvectors corresponds to a number of the largest of the first set of eigenvalues, wherein the number is equal to an estimated number of targets; and code for causing the UWB device to determine a propagation delay value for each of the estimated number of targets based on the second set of eigenvectors.

Additional aspects, features, and advantages of the present disclosure will become apparent from the following detailed description.

### BRIEF DESCRIPTION OF THE DRAWINGS

The accompanying drawing figures incorporated in and forming a part of this specification illustrate several aspects of the disclosure, and together with the description, serve to explain the principles of the disclosure.

FIG. 1 illustrates an example of a sensing scenario, according to some aspects of the present disclosure.

FIG. 2 is a block diagram of an example UWB device, according to some aspects of the present disclosure.

FIG. 3 is a timing diagram of an example sensing operation, according to some aspects of the present disclosure.

FIG. 4 illustrates an example method of sensing operation, according to some aspects of the present disclosure.

FIG. 5 illustrates a graph of field data of an UWB device performing a sensing operation, according to some aspects of the present disclosure.

### DETAILED DESCRIPTION

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

Disclosed herein are UWB systems, methods, and devices for detection and location of multiple targets, both moving and non-moving. Detection and location may be performed using calculations that employ CIR estimates, such as by using covariance matrix estimates based on CIR estimates and performing eigenvalue decompositions techniques using these matrices. Thus, the present disclosure allows for accurate UWB sensing when multiple moving or non-moving targets impact several taps of a CIRE causing the reflections of different targets to overlap.

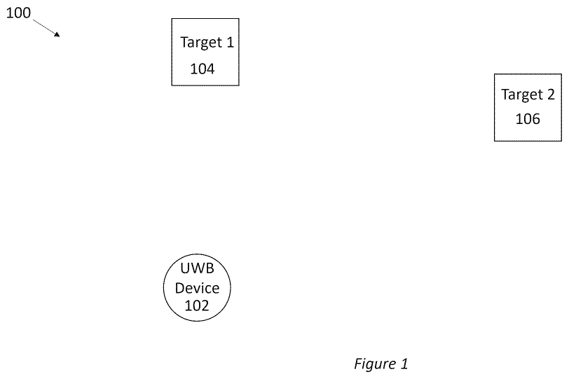

FIG. 1 illustrates an example of a sensing scenario 100, according to some aspects of the present disclosure. In this scenario 100, a UWB device 102 is in the presence of two targets, labeled here as Target 1 104 and Target 2 106. Target 1 104 and Target 2 106 may be each located at a respective distance away from UWB device 102 and at some angle relative to a frame of reference maintained by the UWB device 102. The scenario 100 is representative, as there may be any number of targets (e.g., 0, 1, 2, 3, etc.) in the vicinity of the UWB device 102. Various use cases are embodied by these scenarios, including use cases in which the different targets represent human beings. In such a use case, the targets (people) may be remain in a relatively fixed position for a length of time while moving in place to make gestures using hands or feet. A UWB device, such as UWB device 102, can be used to detect and track the location of the targets.

In order to sense its environment, UWB device 102 may transmit one or more signals at various times and listen for reflections. A transmitted signal may reflect off Target 1 104 and be received by UWB device 102. The transmitted signal may also reflect off Target 2 106 and be received by UWB device 102. In some embodiments, an UWB device 102 may transmit a signal using at least one transmit antenna. In some embodiments, an UWB device may receive a reflected signal using at least one receive antennas. Multiple receive antennas may allow an UWB device 102 to collect additional information that provide for determining angle of arrival (AoA) information relative to the targets. For example, two antennas may be able to determine a difference in phase of reflected signals to estimate AoA. In some embodiments, an UWB device 102 may have one receive antenna.

Using conventional techniques, an UWB device 102 may not be able to distinguish Target One's 104 reflected signal from Target Two's 106 reflected signal, especially if the two targets 104, 106 are relatively close together. In some embodiments, if Target 1 104 and/or Target 2 106 are moving (either in place or in a direction), UWB device 102 may not be able to distinguish Target One's 104 reflected signal from Target Two's 106 reflected signal, especially if the two targets 104, 106 are relatively close together.

In sum, conventional sensing systems typically have difficulty distinguishing multiple targets using CIRE information, especially if targets are moving. Thus, resulting distance and angle calculations may be inaccurate. Disclosed herein are new and improved processing of UWB signals, allowing UWB devices to obtain more accurate distance and angle calculations of objects in sensing applications.

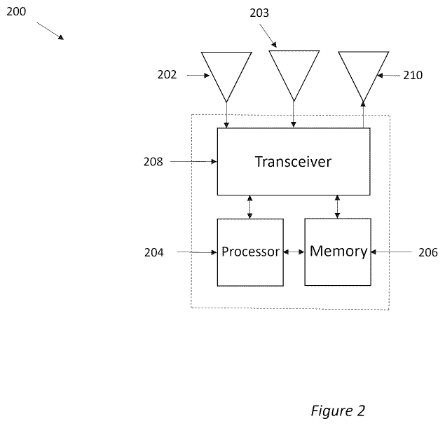

FIG. 2 is a block diagram of an example UWB device 200, according to some aspects of the present disclosure. The sensing device 200 may be capable of operating in any of the sensing configurations presented herein. For example, the UWB device 200 may represent the UWB device 102 of FIG. 1. The sensing device 200 includes a receive antenna 202, a receive antenna 203, a transmit antenna 210, a transceiver 208, a processor 204, and a memory 206. In some embodiments, the transceiver 208 includes a receiver (not shown) and a transmitter (not shown), wherein the receiver includes circuitry controlled by the sensing device 200 for estimating a CIR. In some embodiments, the transceiver 208 is configured to transmit a signal via the transmit antenna 210, and the transceiver 208 is configured to receive the reflected signal via the receive antenna 202, the receive antenna 203, and the receiver. FIG. 2 is exemplary, and a UWB device may include any number of transmit and receive antennas, for example.

In some embodiments, at least one transmit antenna and at least one receive antenna are co-located, such as in single UWB device, such as UWB device 200. The term “co-located” in the UWB arts may refer to a truly monostatic configuration in which a transmit antenna and a receive antenna are located at the same location or to a pseudo-monostatic configuration in which a transmit antenna and a receive antenna are a relatively short distance apart. Some embodiments may use a pseudo-monostatic configuration to determine distance and AoA. In some embodiments, a transmit antenna and a receive antenna are not co-located, which is typically referred to as a bistatic configuration. Some embodiments may use a bistatic configuration to determine distance and AoA. In some embodiments, a transmit antenna and a receive antenna may be part of the same UWB device (e.g., a mono-source configuration). In some embodiments, a transmit antenna and a receive antenna may be part of different UWB devices (e.g., a multi-source configuration). In some embodiments, one UWB device may have more than one transmit antenna and/or more than one receive antenna. For example, an UWB device may have one transmit antenna and two receive antennas. In some embodiments, multiple UWB devices, each or in combination, may have more than one transmit antenna and/or more than one receive antenna. For example, some or all UWB devices from a group of UWB devices may each have one transmit antenna and two receive antennas.

The information from a received signal may be stored in memory 206. The processor 204 may be used to convert information from a signal to other formats. In some embodiments, the other formats may also be stored in the memory 206. In some embodiments, the transceiver 208 may be implemented using a combination of separate transmitter and receiver circuitry (such as analog circuitry) that are connected to other circuitry, such as the processor 204 or other circuitry, for performing baseband processing. In other embodiments the sensing device 200 may include more than two antennas and the selection of which antenna(s) is/are used in transmission and which antenna(s) is/are used for reception may be dynamically controlled by the processor 204. In such embodiment, the use of multiple antennas may provide multiple snapshots of the reflections from the environment which may be then combined by the processor to get a better CIR.

The transceiver 208 may implement UWB sensing capability, such as for transmitting and/or receiving UWB packets, such as described with respect to FIG. 1. The sensing device 200 may represent a smartphone or other device, that also implements Bluetooth, Wi-Fi, cellular, and/or other communication capability, such as by including one or more chips or processors that implement this capability. The transceiver 208 may be implemented as an integrated circuit, or chip.

Memory 206 may include one or more non-transitory storage devices that may include local and/or network accessible storage, a disk drive, a drive array, an optical storage device, a solid-state storage device such as a random access memory (RAM) and/or a read-only memory (ROM), a programmable ROM, a flash-updateable ROM, and/or the like. Such storage devices may be configured to implement any appropriate data storage, including without limitation, various file systems, database structures, and/or the like. The memory 206 may be a non-transitory computer-readable medium used for storing programming instructions and other computer code for carrying out various steps described herein.

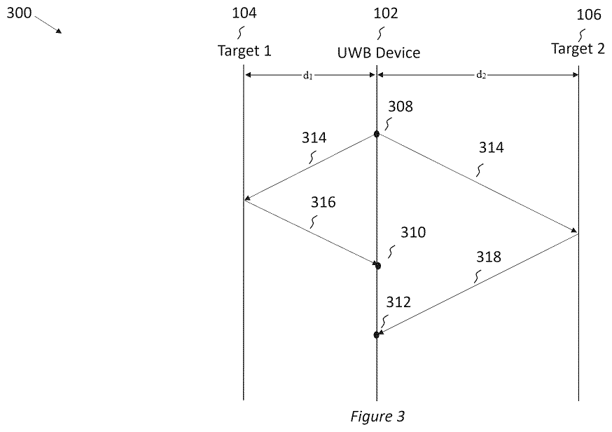

FIG. 3 is a timing diagram 300 of an example sensing operation, according to some aspects of the present disclosure. The timing diagram 300 is for the example sensing scenario 100 in FIG. 1. Target 1 104 and Target 2 106 may be each positioned a distance and/or angle away from UWB device 102. For example, Target 1 104 may be distance d₁ away from UWB device 302, and Target 2 106 may be distance d₂ away from UWB device 102. UWB device 102 may transmit a signal 314 at an initial time t1 308. The signal may reflect off Target 1 104 and be received by UWB device 102 at time t2 310. The signal may also reflect off Target 2 106 and be received by UWB device 102 at time t3 312. If Target 1 104 and Target 2 106 are relatively close together, t2 310 and t3 312 will be relatively close together and may have relatively significant effects on a CIR estimations.

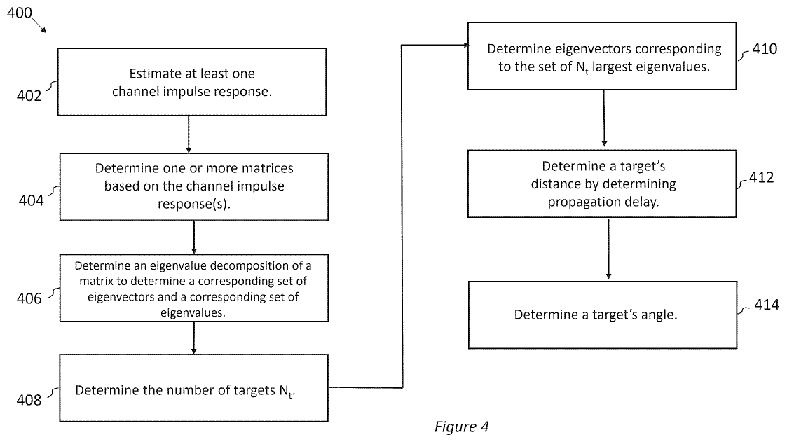

FIG. 4 illustrates an example method 400 of sensing operation, according to some aspects of the present disclosure. The method 400 may be performed in a UWB device, such as the UWB device 200 shown in FIG. 2.

In step 402, at least one CIR is estimated. As part of the CIR estimation, one or more UWB packets or frames may be transmitted from a UWB device, and the CIR may be estimated based on reflections received at the UWB device. There are many known ways to estimate CIR. For example, a CIR may be built on the analysis of an Ipatov sequence (located in a preamble and/or synchronization sequence). As another example, the CIR may be built on the analysis of other parts of a packet or frame and by combining the analysis of the various parts of the packet or frame.

In step 404, one or more matrices may be determined based on CIR estimates. Estimation and analysis of a CIR, which may involve, for example, aggregating the various responses from the environment, may be used to determine the distance to an object, and consequently deduce other information about the object, such as the object's location and velocity. Angle of arrival may also be used to enrich the CIR information and consolidate the estimation of a user's position. Each CIRE's complex components (taps) includes propagation delay information about a reflected signal from a target and thus corresponds to a reflecting target's distance.

Suppose the CIR estimated at time m using assuming sampling rate Tₛ at the ith receive antenna is denoted by the vector

$${c}^{i} ( m ) = [ \begin{matrix}{c}^{i} ( m , 1 ) \\ ⋮ \\ ⋮ \\ {c}^{i} ( m , K )\end{matrix} ] ,$$

where there are K taps in the CIR and c(m,k) denotes the clutter-free kth tap of the CIR at time m. In some embodiments, certain matrices, which also may be referred to as covariance matrices, at time m may computed over a time interval N as follows:

$${\hat{R} ( m )}^{( i , j )} = \frac{1}{N} {\sum }_{n = m - N + 1}^{m} {c}^{( i )} ( n ) {{c}^{( j )} ( n )}^{H}$$

where i and j are antenna indices. Each of c⁽ⁱ⁾(n) and c^{(j)}(n) may be derived from CIR estimates. If i=j, the resulting covariance matrix may be understood as and referred to as an auto-covariance matrix, and if i≠j, the resulting covariance matrix may be understood as and referred to as a cross-covariance matrix. Each of the values c⁽ⁱ⁾(n) c^{(j)}(n)^{H} may itself represent a covariance matrix, and these covariance matrices may be averaged over a time interval N as shown above. For example, a first matrix, where i=j=1, may be computed in step 404.

In step 406, an eigenvalue decomposition a matrix may be computed. Eigenvalue decomposition results in a corresponding set of eigenvectors and a corresponding set of eigenvalues. The eigenvalue decomposition of an auto-covariance matrix may provide a matrix of eigenvectors and/or a set of eigenvectors including a number of eigenvectors corresponding to the signal and noise subspaces. The eigenvalue decomposition of the auto-covariance matrix may also provide a diagonal matrix of eigenvalues and/or a set of eigenvalues corresponding to the matrix of eigenvectors. The eigenvalues may form a diagonal of the eigenvalue matrix. The matrix of eigenvalues may include a number of eigenvalues corresponding to the signal and noise subspaces. The eigenvalue decomposition of the auto-covariance matrix may also provide an inverse matrix of eigenvectors and/or a set of eigenvectors corresponding to the matrix of eigenvectors.

For example, the following equation may represent a resulting eigenvalue decomposition of a first (auto-covariance) matrix:

$${\hat{R} ( m )}^{( i , i )} = U ( m ) Λ ( m ) {U ( m )}^{H} , \qquad ( Eqn . 1 )$$

where U(m) is a square matrix whose jth column is an eigenvector of \hat{R}(m)^{(i,i)}, and Λ(m) is a diagonal matrix whose diagonal elements are the corresponding eigenvalues, Δ, of \hat{R}(m)^{(i,i)}. An eigenvalue decomposition of a matrix, such as \hat{R}(m)^{(i,j)}, may be performed using known techniques. An eigenvalue decomposition may also be referred to as eigendecomposition.

As shown in Eqn. 1 above, the auto-covariance matrix \hat{R}(m)^{(i,j)} is a function of the ith receive antenna. If there is more than one receive antenna, only one matrix (an auto-covariance matrix) at a given time (m) may be computed (for i=1, 2, . . . or n, where n is the number of antennas), and this matrix (which may be referred to as a first matrix) may be used in the eigenvalue decomposition. As an alternative, the auto-covariance matrix may be computed for more than one antenna (e.g., for i=1, 2, etc.) at a given time (m) and the final auto-covariance matrix at a given time (m) for use in the eigenvalue decomposition may be an average of the auto-covariance matrices, averaged over the antennas (averaged over i), such that the eigvenvalue decomposition is based on the average of the auto-covariance matrices at time m.

In step 408, an estimate of the number of targets Nₜ is determined. An estimation of the number of targets may be determined using the set of eigenvalues determined in step 404. For example, the number of targets may be estimated as the number of eigenvalues that exceed a threshold value, such as the noise level, represented by σ². If the number of targets is previously known, the estimated number of targets may be compared to the actual number of targets. In theory, any eigenvalues from the set of eigenvalues greater than a threshold value may belong to a signal subspace. Alternatively, an estimate of the number of targets Nₜ may be determined using any known method and input to the method 400.

In step 410, a signal subspace may be determined based on the estimated number of targets Nₜ. For example, a matrix Uₛ(m) may be determined as containing Nₜ column vectors of U(m) corresponding to the Nₜ largest eigenvalues of \hat{R}(m)^{(i,i)} (e.g., those eigenvalues that exceed a threshold value). Each column vector of Uₛ(m) may correspond to an individual target. The matrix Uₛ(m) may be represented as follows:

$${U}_{s} ( m ) = [ {u}_{1} ( m ) , … , {u}_{{N}_{t}} ( m ) ] ,$$

where each of vectors uᵢ(m) is an eigenvector corresponding to an eigenvalue greater than a threshold.

In step 412, a propagation delay corresponding to each target may be determined. Once Uₛ(m) is determined, a propagation delay may be determined based on the column vectors of Uₛ(m). An estimation of a jth target delay may be obtained from the largest magnitude component of the corresponding eigenvector. For example, a propagation delay for the jth target may be estimated using the following equation:

$${\hat{τ}}_{j} ( m ) = arg max \vert {u}_{j} ( m ) \vert ,$$

where argmax (argument of the maximum) is taken over the magnitudes of the elements of the indicated vector. The propagation delay for the jth target can be used to estimate the distance between a UWB sensing device and the target. Determining the distance may be performed as part of this step or in another step.

In optional step 414, a target's angle may be determined. Determining a target's angle may use a second dimension of information so that the phase difference of two received waves may be determined. While propagation delay may be determined based on a first (e.g., auto-covariance) matrix, a target's angle may be determined based on a second (e.g., cross-covariance) matrix. For an example, a target's angle may be determined based on the following equation:

$${\hat{θ}}_{u} ( m ) = angle ( {\hat{r}}^{( i , j )} ( {\hat{τ}}_{j} ( m ) , {\hat{τ}}_{j} ( m ) ) ) ,$$

where \hat{r}^{(i,j)}(k, k) represents the diagonal elements of \hat{R}(m)^{(i,j)}, which is understood as and may be referred to as a cross-covariance matrix.

As explained earlier, the steps in the method 400 may be performed in a UWB device, such as UWB device 200. For example, a monostatic radar/sensing application may use a single UWB device for transmission of packets or frames and for receiving reflections of those packets or frames. The processor 204 in UWB device 200 may be configured to perform all or part of steps 402 through 414. For example, the processor 204 may be configured to perform various computations as explained with respect to the method 400. A transceiver, such as transceiver 208, may be used to estimate channel impulse response(s). The memory 206 may be used for storing programming instructions and other computer code for carrying out the various steps in the method 400, with the instructions and other computer code in a format for execution by the processor 204 and/or transceiver 208. In some applications, such as where transmit and receive antennas are not co-located, packets or frames may be transmitted from one UWB device and reflections may be received at a different UWB device. In such a case, the steps of method 400 may be performed in the receiving device.

In summary, eigenvalue decomposition may allow the separation of the contribution of different targets making the multi-target detection issue a sum of mono-target detection problems. Eigenvalue decomposition is especially useful when the target distances are relatively small.

Without being bound by theory, some additional background on the method 400 is provided below. For the purpose of the signal model, assume that a signal is reflected by Nₜ moving targets and denote by τᵢ the propagation delay of the signal reflected by the uth target. Denote by r(m, k) the kth tap of the CIR measured at time mA at sampling rate Tₛ·r(m, k) is a complex number, that can coarsely be modeled as:

$$r ( m , k ) = {\sum }_{u = 1}^{{N}_{t}} {β}_{u} ( m ) g ( ( k - {k}_{0} ) {T}_{s} - {τ}_{u} ( m ) ) + C ( k ) + w ( m , k )$$

where m denotes time and k denotes the tap of the CIR. The signal may be reflected by Nₜ moving targets, τᵢ may be the propagation delay of the signal reflected by the uth target, r(m, k) may be the kth tap of the CIR measured at time mA at sampling rate Tₛ·r(m, k)·r(m, k) may be a complex number that may coarsely be modeled as the above equation. βᵢ(m) may be a random complex signal over m and may be the amplitude of target reflection. g(t) may include the transmit and receive filter impulse response. g(t) may be a finite impulse response filter of length L_{g}, having non-zero values from 0 to L_{g}. k₀ may be the number of precursor taps. C(k) may be a value representing the clutter from the environment, and w(m, k) may be a value representing noise.

The clutter free signals c(m, k) may be determined by the following equation:

$$c ( m , k ) = r ( m , k ) - C ( k ) = {\sum }_{u = 1}^{{N}_{t}} {β}_{u} ( m ) g ( ( k - {k}_{0} ) {T}_{s} - {τ}_{u} ( m ) ) + w ( m , k )$$

The CIR vector may be represented using the following equation:

$$c ( m ) = [ \begin{matrix}c ( m , 1 ) \\ ⋮ \\ ⋮ \\ c ( m , K )\end{matrix} ] = [ \begin{matrix}g ( - {k}_{0} {T}_{s} - {τ}_{1} ( m ) ) & … & g ( - {k}_{0} {T}_{s} - {τ}_{{N}_{t}} ( m ) ) \\ ⋮ & & ⋮ \\ ⋮ & & ⋮ \\ g ( ( K - {k}_{0} ) {T}_{s} - {τ}_{1} ( m ) ) & … & g ( ( K - {k}_{0} ) {T}_{s} - {τ}_{{N}_{t}} ( m ) )\end{matrix} ] [ \text{} \begin{matrix}{β}_{1} ( m ) \\ ⋮ \\ {β}_{{N}_{t}} ( m )\end{matrix} ] + [ \begin{matrix}w ( m , 1 ) \\ ⋮ \\ ⋮ \\ w ( m , K )\end{matrix} ] = G ( m ) b ( m ) + w ( m )$$

As stated previously, a multi-antenna model may allow for the determination of the target's angle. Accordingly, the CIR may be more precisely represented by the following equation:

$${r}^{( i )} ( m , k ) = {\sum }_{u = 1}^{{N}_{t}} {β}_{u} ( m ) {a}^{( i )} ( {θ}_{u} ( m ) ) g ( ( k - {k}_{0} ) {T}_{s} - {τ}_{u} ( m ) ) + C ( k ) + w ( m , k ) ,$$

$$where$$

$${a}^{( i )} ( {θ}_{u} ( m ) ) = {e}^{\frac{4 i π}{λ} {d}_{u}^{( i )} ( m ) + {ϕ}^{( i )}}$$

The distances between a target u and a first antenna and second antenna, respectively may be represented by the following equation:

$${d}_{u}^{( 2 )} ( m ) = {d}_{i}^{( 1 )} ( m ) + D cos ( {θ}_{u} ( m ) ) ,$$

where, D may be a distance between an antenna and θ the angle of arrival, distances dᵢ⁽¹⁾(m) and dᵤ⁽²⁾(m) may be a distance between the target u and a first antenna and second antenna, respectively.

Accordingly, the equation for a CIR vector may become:

$${c}^{( i )} ( m ) = G ( m ) {A ( m )}^{( i )} b ( m ) + w ( m ) ,$$

$$where$$

$${A ( m )}^{( i )} = diag ( {a}^{( i )} ( {θ}_{1} ( m ) ) , … , {a}^{( i )} ( {θ}_{{N}_{t}} ( m ) ) )$$

Further, the auto-covariance matrix may be determined by the following equation:

$${R}^{( i , i )} = E [ {c}^{( i )} ( m ) {{c}^{( i )} ( m )}^{H} ] = E [ G ( m ) {A ( m )}^{( i )} b ( m ) {b ( m )}^{H} {A ( m )}^{{( i )}^{H}} {G ( m )}^{H} ] + {σ}^{2} {I}_{K}$$

$$As E [ {c}^{( i )} ( m ) ] = 0$$

Moreover, the above representation of the auto-covariance matrix may assume that the noise coefficients are uncorrelated and that each tap is affected by the same threshold value for noise level (for example, σ²).

If the different targets stay at a constant position from the UWB device while doing small body movements, then the matrices G(m) and A(m)⁽ⁱ⁾ may be constant over m. Thus, the auto-covariance matrix may be represented as:

$${R}^{( i , i )} = {GA}^{( i )} {A}^{{( i )}^{H}} {BG}^{H} + {σ}^{2} {I}_{K} ,$$

where A⁽ⁱ⁾A⁽ⁱ⁾^{^{H}} and B=E[b(m)b(m)^{H}] may be real diagonal matrices of rank Nₜ. Under certain conditions, G may also be of rank Nₜ.

The eigenvalue decomposition of the auto-covariance matrix may be determined:

$${R}^{( i , i )} = {U}_{s} diag ( {λ}_{1} + {σ}^{2} , … , {λ}_{{N}_{t}} + {σ}^{2} ) {U}_{s}^{H} + {σ}^{2} {U}_{n} {U}_{n}^{H}$$

where under certain conditions, the subspace vectors Uₛ may be very closely related to G, and, in some embodiments, U_{S}≈GDP (where D may be a diagonal matrix and P may be a permutation matrix).

Therefore, the jth column of U_{S} may be determined by the following equation:

$${u}_{j} \approx {{α}_{j} [ g ( - {k}_{0} {T}_{s} - {τ}_{u} ) … g ( ( K - {k}_{0} ) {T}_{s} - {τ}_{u} ) ]}^{T}$$

Many different algorithms may be used to extract estimates of {τᵤ} from the signal subspace. For example, one may determine an index of the maximal amplitude taps of each column of U_{S}. For another example, one might use interpolation technique(s) to calculate a potentially more accurate estimate of propagation delay(s).

Eigenvalue decomposition may allow for separation of the contribution of different targets. Thus, eigenvalue decomposition may make the multi-target detection problem, in essence, a sum of mono-target detection problems. When target distances are close, eigenvalue decomposition might be especially useful.

The cross-covariance matrix may be determined by the following equation:

$${R}^{( i , j )} = E [ {c}^{( i )} ( m ) {{c}^{( j )} ( m )}^{H} ] = E [ G ( m ) {A ( m )}^{( i )} b ( m ) {b ( m )}^{H} {A ( m )}^{{( j )}^{H}} {G ( m )}^{H} ] + E [ {w}^{( i )} ( m ) {{w}^{( j )} ( m )}^{H} ] = {GA}^{( i )} {A}^{{( j )}^{H}} {BG}^{H}$$

where, A⁽ⁱ⁾A^{(j)}^{^{H}} may be a diagonal matrix whose uth diagonal element is equal to ϕ⁽ⁱ⁾-ϕ^{(j)}±D cos(θᵤ). δΦ=ϕ⁽²⁾−ϕ⁽¹⁾ which may be a constant phase that must be evaluated by calibration.

Therefore, in a noise free condition, target angle may be represented as:

$${r}^{( i , j )} ( {τ}_{u} , {τ}_{u} ) = δ Φ \pm D cos ( {θ}_{u} )$$

A target's angle may be estimated from the diagonal elements of R^{(i,j)}.

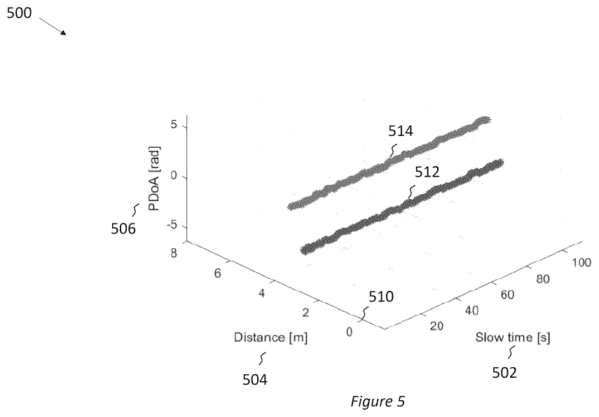

FIG. 5 illustrates a graph 500 of field data of an UWB device having two receive antennas and performing a sensing operation in the presence of two targets, according to some aspects of the present disclosure. In the experiments, UWB packets were transmitted every 10 ms and received alternatively on two antennas. The two targets in this example were located at 2.8 and 3.1 meters, respectively, from the UWB sensing device. FIG. 5 is an example graph 500 of field data exemplifying the effectiveness of the disclosed embodiments. The graph 500 illustrates slow time 502 in seconds on the x-axis, distance 504 in meters on the y-axis, and phase distance of arrival (PdoA) in radians on the z-axis. The origin (0,0,0) 510 represents a location of an UWB device. First plot 512 represents the first object approximately 2.8 meters away which is moving in place. Second plot 514 represents the second object about 3.1 meters away which is moving in place. Data was obtained over a period of 120 seconds. As can be seen from FIG. 5, the plots of estimated distance and PdoA are accurate and consistent.

Persons skilled in the art will recognize that the apparatus, systems, and methods described above can be modified in various ways. Accordingly, persons of ordinary skill in the art will appreciate that the embodiments encompassed by the present disclosure are not limited to the particular exemplary embodiments described above. In that regard, although illustrative embodiments have been shown and described, a wide range of modification, change, and substitution is contemplated in the foregoing disclosure. It is understood that such variations may be made to the foregoing without departing from the scope of the present disclosure. Accordingly, it is appropriate that the appended claims be construed broadly and in a manner consistent with the present disclosure.

What is claimed is:

1. A method of sensing operation performed by an ultra-wideband (UWB) device, the method comprising:
determining a first matrix based on one or more estimated channel impulse responses;
determining a first set of eigenvectors and a first set of eigenvalues based on the first matrix;
determining a second set of eigenvectors by identifying which of the first set of eigenvectors corresponds to a number of the largest of the first set of eigenvalues, wherein the number is equal to an estimated number of targets; and
determining a propagation delay value for each of the estimated number of targets based on the second set of eigenvectors.

2. The method of claim 1, wherein the method further comprises:
determining a second matrix based on the one or more channel impulse responses; and
determining an angle for each of the estimated number of targets based on the second matrix.

3. The method of claim 1, wherein the determining the first set of eigenvectors and the first set of eigenvalues based on the first matrix further comprises determining the first set of eigenvectors and the first set of eigenvalues based on an eigenvalue decomposition of the first matrix.

4. The method of claim 1, wherein the determining the propagation delay value for each of the estimated number of targets comprises, for each of the estimated number of targets, determining an argument of the maximum of the magnitude of the elements of the eigenvector corresponding to the target.

5. The method of claim 1, further comprising:
determining a second set of eigenvalues by identifying which of the first set of eigenvalues exceeds a threshold value, wherein the estimated number of targets corresponds to a number of the second set of eigenvalues, and wherein the threshold value is based on an estimation of noise.

6. The method of claim 1, wherein the UWB device comprises a plurality of receive antennas, and wherein the one or more estimated channel impulse responses comprises at least one estimated channel impulse response for each receive antenna.

7. The method of claim 1, wherein the one or more estimated channel impulse responses comprises a plurality of estimated channel impulse responses, each of which is computed at a different time, and wherein the first matrix is based on computing an average using the plurality of channel impulse responses.

8. The method of claim 6, wherein the first matrix is computed as an average of auto-covariance matrices over the plurality of antennas.

9. The method of claim 2, further comprising determining a distance to each of the estimated number of targets based on the corresponding propagation delay value.

10. The method of claim 1, further comprising:
determining the one or more estimated channel impulse responses based on one or more received UWB signals.

11. The method of claim 10, further comprising transmitting a UWB signal, wherein the one or more received UWB signals represents one or more reflections of the transmitted UWB signal.

12. An ultra-wideband (UWB) device comprising:
a processor configured to:
determine a first matrix based on or more estimated channel impulse responses;
determine a first set of eigenvectors and a first set of eigenvalues based on the first matrix;
determine a second set of eigenvectors by identifying which of the first set of eigenvectors corresponds a number of the largest of the first set of eigenvalues, wherein the number is equal to an estimated number of targets; and
determine a propagation delay value for each of the estimated number of targets based on the second set of eigenvectors.

13. The UWB device of claim 12, wherein the processor is further configured to:
determine a second matrix based on the one or more channel impulse responses; and
determine an angle for each of the estimated number of targets based on the second matrix.

14. The UWB device of claim 12, wherein the determining the first set of eigenvectors and the first set of eigenvalues based on the first matrix further comprises determining the first set of eigenvectors and the first set of eigenvalues based on an eigenvalue decomposition of the first matrix.

15. The UWB device of claim 12, wherein the determining the propagation delay value for each of the estimated number of targets comprises, for each of the estimated number of targets, determining an argument of the maximum of the magnitude of the elements of the eigenvector corresponding to the target.

16. The UWB device of claim 12, further comprising a plurality of receive antennas, wherein the one or more estimated channel impulse responses comprises at least one estimated channel impulse response for each receive antenna.

17. The UWB device of claim 12, wherein the one or more estimated channel impulse responses comprises a plurality of estimated channel impulse responses, each of which is computed at a different time, and wherein the first matrix is based on computing an average using the plurality of channel impulse responses.

18. The UWB device of claim 12, wherein the processor is further configured to:
determine a second set of eigenvalues by identifying which of the first set of eigenvalues exceeds a threshold value, wherein the estimated number of targets corresponds to a number of the second set of eigenvalues.

19. A non-transitory computer-readable medium (CRM) having program code recorded thereon, the program code comprising:
code for causing an ultra-wideband (UWB) device to determine a first matrix based on one or more estimated channel impulse responses;
code for causing the UWB device to determine a first set of eigenvectors and a first set of eigenvalues based on the first matrix;
code for causing the UWB device to determine a second set of eigenvectors by identifying which of the first set of eigenvectors corresponds to a number of the largest of the first set of eigenvalues, wherein the number is equal to an estimated number of targets; and
code for causing the UWB device to determine a propagation delay value for each of the estimated number of targets based on the second set of eigenvectors.

20. The non-transitory CRM of claim 19, further comprising:
code for causing the UWB device to determine a second matrix based on the one or more channel impulse responses; and
code for causing the UWB device to determine an angle for each of the estimated number of targets based on the second matrix.
